(19) United States
(12) Patent Application Publication
(10) Pub. No.: US 2013/0304448 A1
(43) Pub. Date: Nov. 14, 2013

(54) CONFIGURATION DEVICE FOR CONFIGURING A MODEL OF A TECHNICAL SYSTEM

(71) Applicants: Martin Ruehl, Altenbeken (DE); Karsten Kruegel, Paderborn (DE); Bjoern Mueller, Lippstadt (DE)

(72) Inventors: Martin Ruehl, Altenbeken (DE); Karsten Kruegel, Paderborn (DE); Bjoern Mueller, Lippstadt (DE)

(73) Assignee: dSPACE digital signal processing and control engineering GmbH, Paderborn (DE)

(21) Appl. No.: 13/466,261

(22) Filed: May 8, 2012

(51) Int. Cl. G06F 17/50

(52) U.S. Cl. 703/13

(57) ABSTRACT

A configuration tool includes a tangible, non-transitory computer-readable medium having computer-executable instructions for configuring a model of a technical system and displaying the model on a display connected to a computer. The model includes at least two model components. Each model component has at least one port. Each model component is displayable in an expanded component representation on the display. The at least one port of each model component is connectable to at least one port of another model component by port association lines. Each model component is displayable in an expanded line representation on the display along with the at least one port and the port association lines of each model component. At least for one selected model component the port association lines connected to ports of the selected model component can be selected to be displayed in a reduced line representation.

### FIELD

The present invention relates to a configuration tool for configuring a model of a technical system on a computer having a display, said model including at least two model components, and each model component having at least one port, said model components being displayable in an expanded component representation on the display of the computer, said ports of the model components being connectable by port association lines, and, in an expanded line representation, said model components being displayable on the display of the computer along with their ports and the port association lines between the ports.

### BACKGROUND

Configuration tools are known in the prior art. The model of a technical system is typically a block-based, abstract graphical representation of a technical system that exists in reality and is frequently a control system including an electronic processing unit and I/O devices connected to said processing unit. Such technical systems can be very complex. For example, they may model the entire electronics of a motor vehicle and include thousands of model components, which are connected to each other via their inputs and outputs (ports) via respective connecting lines (port association lines) and, thus, are in operative connection with one another.

The model components may be of the same type. For example, they may include only model components of an abstract mathematical model of the technical system, such as known from block diagrams in control engineering, which are used to describe the physical/technical functionality of the technical system using mathematical means (transfer functions, look-up tables, etc.).

However, models of a technical system which are created and used in a configuration tool frequently include different types of model components. The reason for this is that these models are created of technical systems, or of parts of technical systems, in order to interact with other, real technical systems, or with parts of real technical systems. This scenario occurs, for example, in the development of electronic control units (ECUs) and in the development of open- and closed-loop control systems to be implemented in control units. Here, the control unit is frequently in the form of a piece of hardware that is to be tested and has suitable I/O interfaces. To enable reliable and easy testing of the control unit, the environment of the control unit—a physical process—is modeled with the aid of a mathematical model in a simulator capable of computing the physical process in real-time. The variables to be measured by the control unit, and those to be output in response thereto by the control unit, are measured and output, respectively, via suitably programmable I/O interfaces of the simulator. The aforedescribed method is also referred to as hardware-in-the-loop simulation.

There are other applications for creating models of technical systems, which may be summarized under the term “rapid control prototyping”. Going back to the aforementioned set-up, the control unit and the control system to be implemented in the control unit are here simulated and tested together with the real technical process. In both test scenarios, for which the model of a technical system, or of a part or a technical system, is to be created, the different portions of the test system; i.e., the control unit hardware, the I/O interfaces of the simulator, and the mathematical model of the technical process, are combined in the simulator.

A configuration tool, in which the model of the technical system includes different types of model components (i.e., model components of the mathematical model and/or model components of the I/O interfaces and/or model components of existing real hardware) is described, for example, in US 2008/0091279 A1. In this configuration tool, the model components can be displayed in an expanded component representation and in a reduced component representation. In the reduced component representation, the respective model component is only represented by a block that contains the name of the reduced model component and does not provide any information about the ports of the model component shown. In the reduced component representation, the ports of the respective model component are replaced by a reduced port, and the ends of the port association lines, which were connected to the ports of the model component that was previously shown expanded, but is now shown reduced, are connected to one single reduced port of the model component in reduced component representation. The manner in which the port association lines are displayed is governed solely by the selection of whether a model component is to be displayed in expanded or reduced component representation.

Due to the large number of model components in a model of a technical system, the selection of the reduced component representation for a model component provides an important way to reduce the immense complexity for a person working on the model, and to hide information that is less important for a particular work operation. However, when the representation of a model component is changed from expanded component representation to reduced component representation, a relatively large amount of data is hidden at once in one large step, so that it may be necessary to switch between the modes of representation of the model component relatively often during the development process.

### SUMMARY

In an embodiment, the present invention provides a configuration tool including a tangible, non-transitory computer-readable medium having computer-executable instructions for configuring a model of a technical system and displaying the model on a display connected to a computer. The model includes at least two model components. Each model component has at least one port. Each model component is displayable in an expanded component representation on the display. Each of the at least one port of each of the model components is connectable to at least one other port of another of the model components by a respective port association line. Each model component is displayable in an expanded line representation on the display along with each of the at least one port and the port association line. The respective port association lines connected to ports of a selected model component are selectable so as to be displayed in a reduced line representation at least at the ends thereof connected to the selected model component and independently of the representation of the selected model component, whereby in the reduced line representation, the selected model component has a reduced port different from the ports of the model component, and the ends of the port association lines connected to the ports of the selected model component in the expanded line representation are represented as one or more component association lines connected to the reduced port in the reduced line representation.

### BRIEF DESCRIPTION OF DRAWINGS

FIG. 1 shows a first exemplary embodiment of a model of a technical system with only one port association line, which was created using the configuration tool of the present invention;

FIG. 2 shows another exemplary embodiment, which is based on the model of a technical system illustrated in FIG. 1, but has two port association lines;

FIG. 3 shows a further exemplary embodiment of models of a technical system with functionally available ports and reduced ports which, however, are not graphically depicted as such;

FIG. 4 shows another exemplary embodiment of a model created using the configuration tool of the present invention, with model components in expanded component representation and expanded line representation;

FIG. 5 shows the exemplary embodiment of FIG. 4 with model components in expanded component representation and partly in reduced line representation;

FIG. 6 shows the exemplary embodiment of FIG. 4 with model components in expanded component representation and completely reduced line representation;

FIGS. 7a and 7b show the exemplary embodiment of FIG. 4 with model components in reduced component representation but expanded line representation (FIG. 7a), and in reduced component representation and completely reduced line representation (FIG. 7b), and

FIG. 8 shows the exemplary embodiment of FIG. 4 with different combinations of component and line representations.

### DETAILED DESCRIPTION

In an embodiment, the present invention provides a configuration tool which allows the complexity of a model of a technical system to be incrementally reduced, thereby making it easier to work on such a model using the configuration tool.

In an embodiment, for one selected model component, the port association lines connected to the ports of the selected model component can be selected to be displayed in a reduced line representation at least at the ends connected to the selected model component and independently of the representation of the selected model component itself, whereby in the reduced line representation, the selected model component has exactly one reduced port different from the ports of the model component, and the ends of the port association lines previously connected to the ports of the selected model component are connected as component association lines only to the reduced port. The feature of the present invention by which the mode of line representation is selectable for a model component; i.e., for the port association lines connected to the model component, independence from the representation of the model component itself allows the complexity of the model representation to be defined in finer increments and in a manner convenient for a developer. In accordance with the present invention, this feature allows the user of the configuration tool to vary the level of complexity of the lines between the model components independently of the representation of the model components. For example, all port association lines between two model components can be replaced by one single component association line by specifying for each model component that the port association lines connected thereto are to be represented in reduced line representation only as component association lines at a single connection point, whereby a plurality of port association lines will automatically become a single component association line. At the same time, the expanded component representation can be maintained, allowing the developer to retain an overview of the contents of the model component, which was previously impossible.

Functionally, the ports of the model components are connection points for the port association lines. The ports may be represented at or in the model components in a graphically highlighted form, but need not be indicated by separate graphical elements. For example, the potential connection points may be identified by the user only by the fact that the names of the ports are positioned in the model components closely adjacent to the potential connecting points.

In an embodiment, the configuration tool according to the present invention has the feature that the component association lines are displayed differently from the port association lines, particularly in a different color and/or in a different line style. This offers the user of the configuration tool the advantage of being able to tell from the line alone whether it is a port association line, which begins or ends at a particular port of a model component. This is of particular advantage when the model components connected by the respective line are far apart from each other, so that the connected model components cannot be displayed simultaneously by the display of the configuration tool. The different representation of port association lines and component association lines makes it much easier to identify and trace port and component association lines.

In one embodiment of the configuration tool according to the present invention, the model components may also at least in part be displayed in a reduced component representation as an alternative to the expanded component representation with simultaneous display of the ports. When the reduced component representation is selected for a model component, while at the same time the expanded line representation is selected for the connected ports of the model component, any unconnected ports that may be present are not displayed; i.e., they are reduced. In contrast, when at the same time the reduced line representation is selected for the connected ports of the model component, then no port is displayed and, consequently, all ports are reduced. The configuration tool so designed allows the complexity of the model to be varied in even finer increments, namely in that when the reduced component representation and the expanded line representation are active at the same time, only those ports which are unconnected are excluded from display, while the ports that are involved in the signal exchange within the model will in any case continue to be displayed. The degree to which a model component can be reduced in the reduced component representation is governed by the selection of the line representation (expanded or reduced). Thus, the mode of line representation has a higher priority than the type of component representation.

The inventive configuration tool for configuring a model of a technical system can be embodied and refined in many ways. In this regard, reference is made to the following description of exemplary embodiments in conjunction with the drawings.

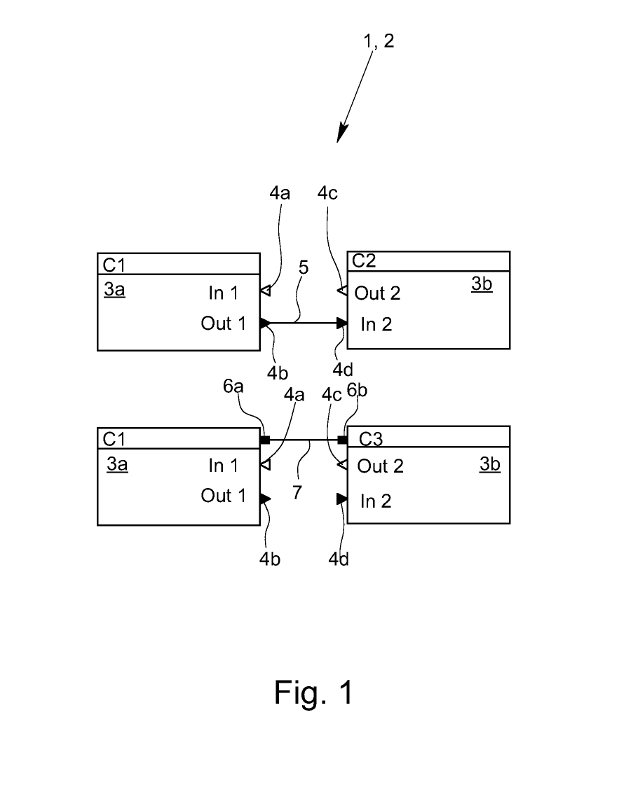

In all of the Figures, configuration tools 1 for configuring a model 2 of a technical system are shown at least to the extent that model 2, which can be processed using the configuration tool, is at least partially shown in the same manner as it would be displayed on a display connected to a computer; i.e., on a monitor. As is apparent from all of the Figures, model 2 includes at least two model components 3a, 3b, and each model component 3a, 3b has at least one port 4. In FIGS. 1 through 3, the ports are separately denoted by reference numerals 4a, 4b, 4c and 4d. In FIGS. 1 through 3, model components 3a, 3b are each shown in an expanded component representation, so that ports 4 of the respective model components 3a, 3b are clearly visible. Functionally, a port 4 is a connection point for port association lines 5, by which ports 4 of model components 3a, 3b can be and, in the exemplary embodiments shown are actually (at least partially), connected to each other.

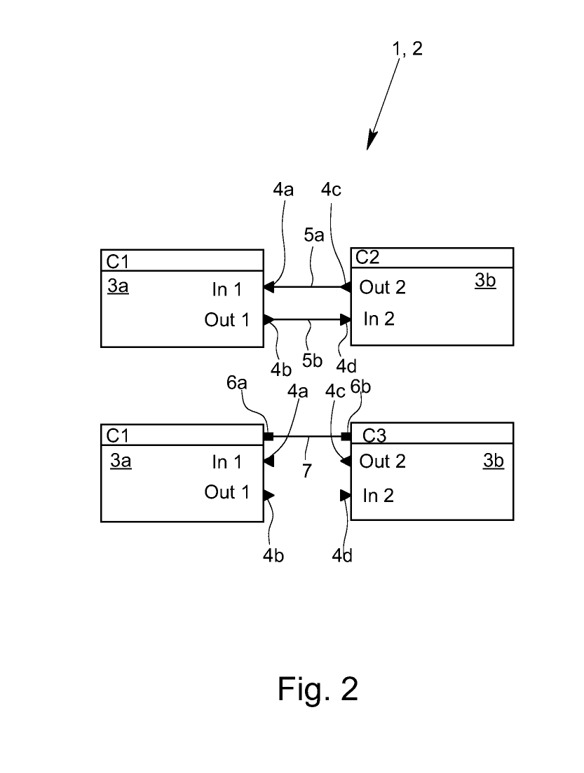

The model components 3a, 3b that are shown topmost in FIGS. 1 through 3 are connected to each other, and additionally exhibit an expanded line representation, in which model components 3a, 3b are depicted along with their ports 4 and port association lines 5, 5a, 5b. In the exemplary embodiment of FIG. 1, a port association line 5 present between ports 4b and 4d illustrates the implementation of the signal flow between model components 3a, 3b. The two lower model components 3a, 3b in FIG. 1 are the same as those shown above, but here it is specified for the two model components 3a, 3b that port association line 5 connected to ports 4b, 4d of model components 3a, 3b is to be displayed in a reduced line representation at the two ends connected to the selected model components 3a, 3b. The term “reduced line representation” means that the selected model components 3a, 3b each have exactly one reduced port 6a, 6b different from ports 4a, 4b and 4c, 4d, respectively, and that the ends of port association line 5, which were previously connected to ports 4b, 4d of the selected model components 3a, 3b, are connected as a component association line 7 only to the respective reduced ports 6a, 6b. While FIG. 1 illustrates the principle of functioning of the reduced line representation, the advantages offered by the possibility of reduced line representation can be seen more readily from FIGS. 2 through 8.

In the exemplary embodiment of FIG. 2, again, the model components 3a, 3b shown above are connected by two port association lines 5a, 5b, port association line 5a extending between ports 4a and 4c, and port association line 5b extending between ports 4b and 4d. When switching from expanded line representation shown in the upper part of the figure to reduced line representation shown in the lower part of the figure, the two port association lines 5a, 5b are replaced by a component association line 7 between reduced ports 6a, 6b. Here, unlike the prior art configuration tools, model components 3a, 3b continue to be displayed in the expanded component representation. The option of selecting the additional property of reduced line representation makes it now possible to reduce the complexity of port association lines 5 between model components 3 without at the same time affecting the complexity of the representation of model components 3.

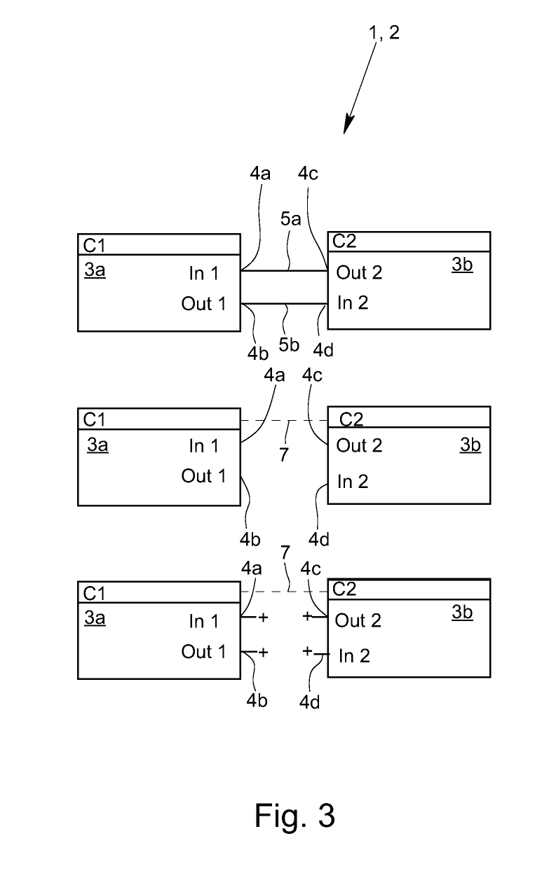

In FIGS. 1 and 2, ports 4 are graphically differently depicted to illustrate different options for implementation. In the view of FIG. 3, ports 4 are not indicated by separate graphical elements. Instead, the potential connection points are indicated to the user only by the fact that the names of the ports (In 1, Out 1; In 2, Out 2) are positioned in model components 3a, 3b closely adjacent to the potential connecting points. The uppermost representation of FIG. 3 again shows model components 3a, 3b both in the expanded component representation and in the expanded line representation. In the central representation of FIG. 3, the line representation is reduced while the component representation is expanded. Component association line 7 is displayed differently from port association lines 5a, 5b in the upper representation, namely as dashes instead of a solid line. The same is also true for the lower representation of model components 3a, 3b in FIG. 3. Here, however, extensions at ports 4a, 4b, 4c, 4d indicate to the user that port association lines are connected to these ports 4a, 4b, 4c, 4d in the expanded line representation.

Overall, it is useful in this connection if in the reduced line representation, the ports 4 of model components 3 that are connected with at least one port association line 5 in the expanded line representation are displayed differently from those ports 4 of model components 3 which are not connected with any port association line in the expanded line representation. This can be seen, for example, from FIG. 1, where ports 4a, 4c, which in the (upper) expanded line representation, too, are not connected with a port association line, are displayed differently from ports 4b, 4d, which are connected with a port association line 5 in the expanded line representation. Thus, in the reduced line representation, it is always possible to see which ports 4 are connected to other ports in the expanded line representation.

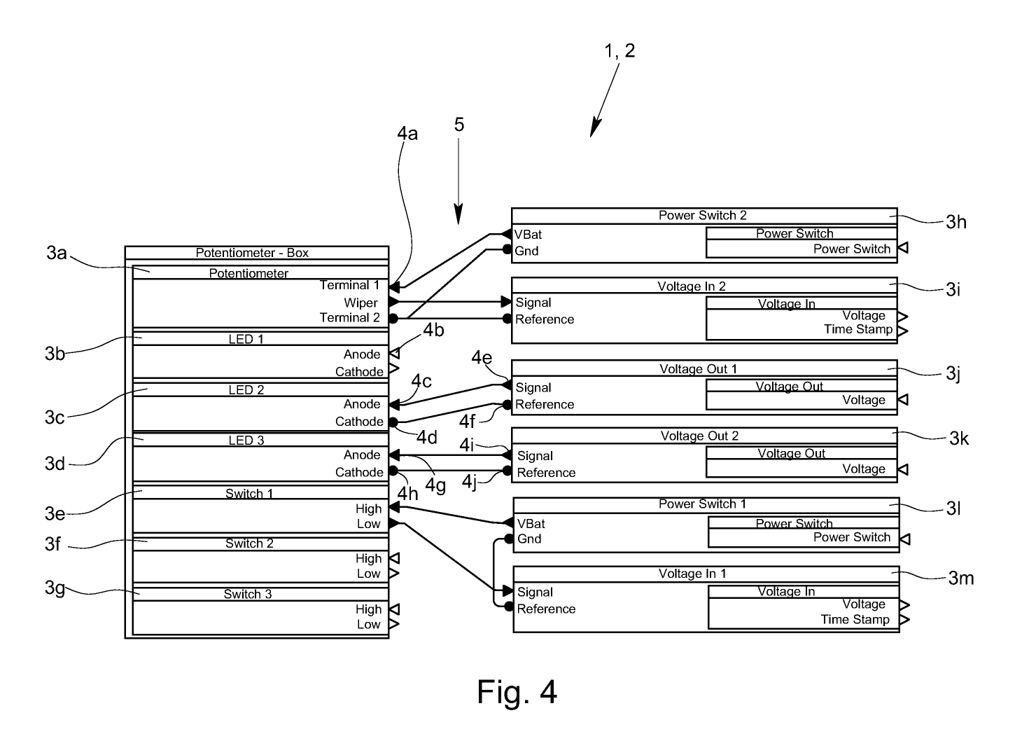

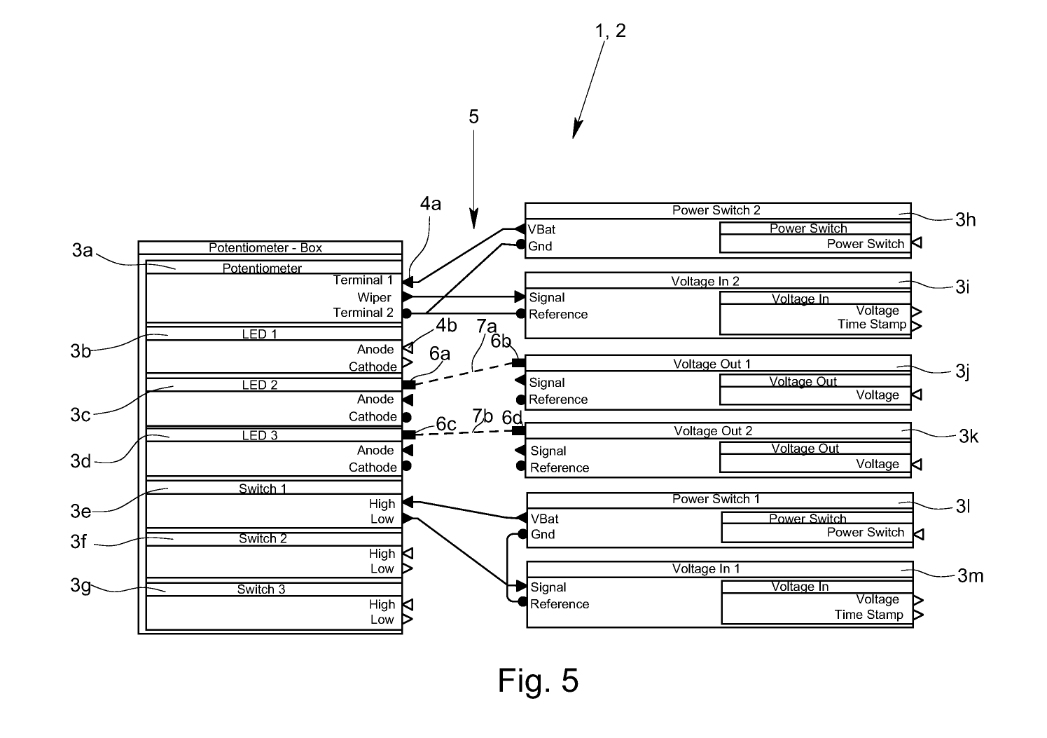

In FIGS. 4 through 8, the operating principle of the configuration tool 1 according to the present invention is illustrated by way of a practical example. The exemplary embodiment of FIG. 4 constitutes the basis for the representations in FIGS. 5 through 8. In the left portion of model 2 shown in FIG. 4, seven model components 3a, . . . , 3g are grouped in a higher-level model component named “potentiometer box”, as part of a hierarchical scaling of model components. In the right portion of model 2, there are six further model components 3h, . . . , 3m. In FIG. 4, both an expanded component representation and an expanded line representation were selected for the representation, so that ports 4 can be seen on all model components 3. In the expanded component representation, too, ports 4 which are connected with port association lines 5; i.e., all ports 4 provided with reference numerals, except for port 4b, are displayed such that they can be distinguished from those ports which are not connected with port association lines 5 such as, for example, port 4b.

The exemplary embodiment of FIG. 5 is based on that of FIG. 4. However, it has been specified for model components 3c, 3d, 3j and 3k that the port association lines 5 connected to their ports 4c, . . . , 4j are to be displayed in a reduced line representation, which is why port association lines 5 between ports 4c and 4e, ports 4d and 4f, ports 4g and 4i as well as between ports 4h and 4j are omitted and replaced by component lines 7a, 7b between reduced ports 6a and 6b and between reduced ports 6c and 6d, respectively. As can readily be appreciated, the detailed information as to which ports 4 are connected to which other ports 4 is thereby omitted, while keeping the information about the model components 3 of model 2 between which there is, in principle, an operative connection via port association lines, at least in the expanded line representation. In any case, it can be seen in FIG. 5 that only a part of all the model components 3 of model 2 are displayed with reduced line representation. This part of model components 3 can be selected by the user of configuration tool 1.

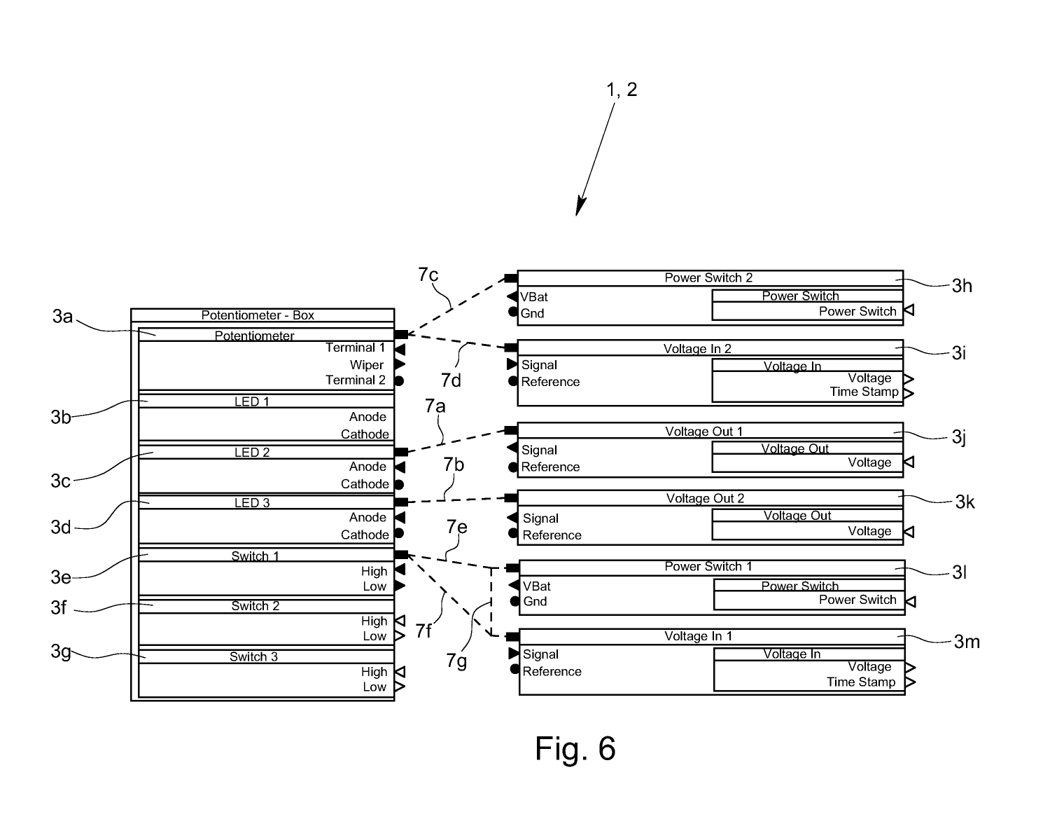

The exemplary embodiment of FIG. 6 is also based on that of FIG. 4, but in contrast to the exemplary embodiment of FIG. 5, the reduced line representation has been specified for all port association lines 5; i.e., for all ports 4 of all model components 3. This has the effect that, in addition to component association lines 7a, 7b, which have resulted in FIG. 5, now further component association lines 7c, 7d, 7e and 7f as well as 7g are produced.

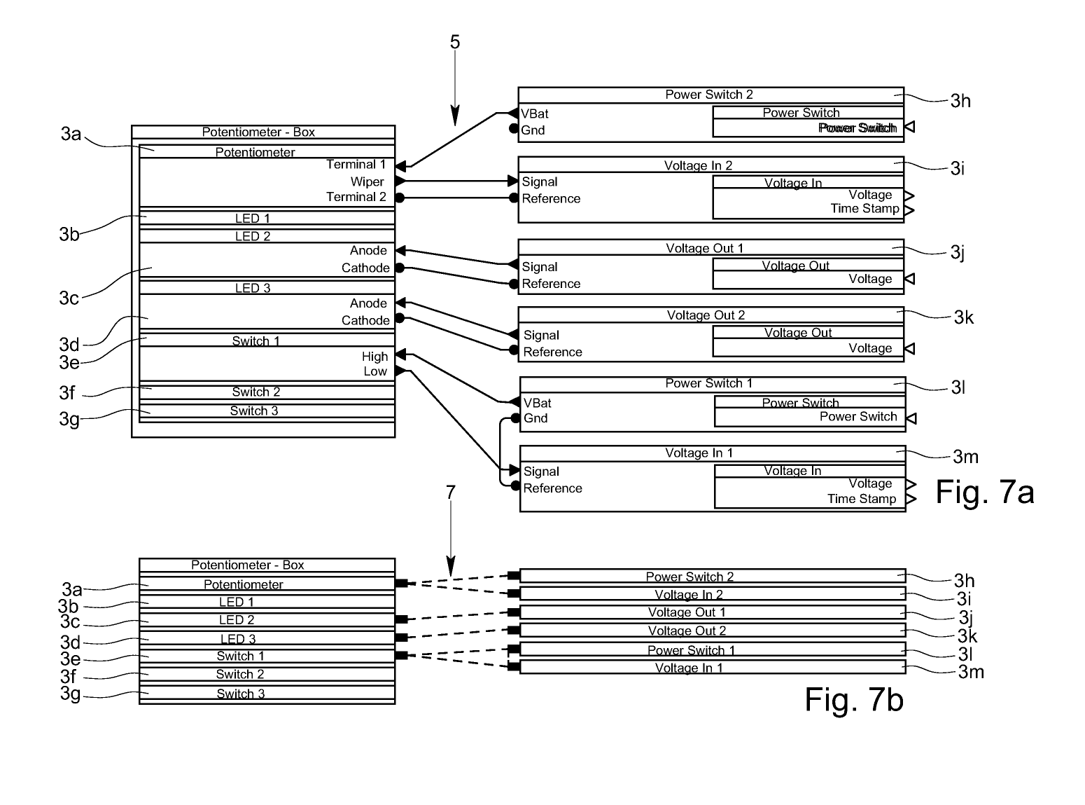

In the exemplary embodiments of FIG. 7, it is shown for the first time that model components 3 may also be displayed in a reduced component representation as an alternative to the expanded component representation with simultaneous display of ports 4 of model components 3. In FIG. 7a, this applies to model components 3b, 3f and 3g. In the reduced component representation of model components 3, ports 4 are no longer visible. What is special about the exemplary embodiment of FIG. 7a is that when at the same time the expanded line representation is selected for the connected ports 4 of model components 3, only unconnected ports are not shown; i.e., reduced. Since, as shown in FIG. 4, ports 4 of model components 3b, 3f and 3g are unconnected, it is only these model components 3b, 3f, 3g that are minimized in the reduced component representation. By also selecting the expanded line representation, the other model components 3a, 3c, 3d, 3e and 3h through 3m are prevented from being reduced.

In FIG. 7b, unlike in FIG. 7a, a reduced line representation has been selected for all connected ports 4 of model components 3, so that model components 3a through 3m are no longer prevented from switching to the reduced component representation. In other words, the selection of the line representation takes precedence over the selection of the component representation.

All of the exemplary embodiments described hereinbefore have in common that when the reduced line presentation is specified for a particular model component 3, all port association lines 5 of this particular model component 3 to other connected model components are replaced by component association lines 7; i.e., by association lines which begin or end at a reduced port 6.

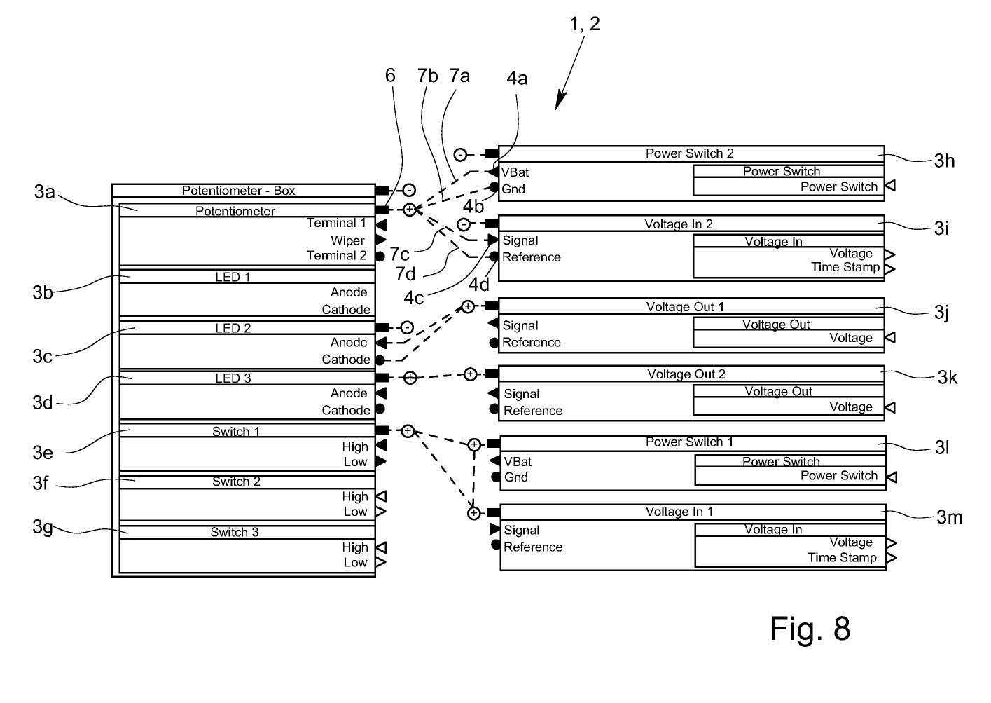

The exemplary embodiment of FIG. 8 shows the result of a representation of model 2, in which all model components 3a, . . . , 3m are displayed in the expanded component representation and where the reduced line representation was selected only for model components 3a, 3d, 3e and 3j through 3m. The expanded line representation continues to be active for model components 3c, 3h and 3i. In this exemplary embodiment it can be seen what happens when different line representations are selected for model components 3a, 3h, 3i and 3c, 3j. In the case of model components 3a, 3h and 3i, this results in that the port association lines 5 shown in the expanded representation (FIGS. 4, 5 and 7a) end at a reduced port 6 only in model component 3a, and in that component association lines 7a through 7d end at unreduced ports 4a, 4b, 4c and 4d in the model components 3h, 3i for which no reduced line representation was selected.

In FIG. 8, in addition to reduced port 6 of model component 3a, all other model components which are not identified by a separate reference numeral also have reduced ports. All reduced ports are provided with an appendix which ends with a plus sign (+) in a circle or with a minus sign (−) in a circle. The two circular symbols indicate the mode of line representation (reduced or expanded) that was selected for the model component; i.e. for the ports of the respective model component. The plus sign in the circle is indicative of a reduced line representation, which may be expanded by clicking on the plus sign. Analogously, the minus sign in the circle is indicative of an expanded line representation, which may be reduced by clicking on the minus sign. Clicking on the plus or minus sign does not only change the mode of line representation, but also changes the sign displayed in the respective circle accordingly; i.e., from plus to minus and vice versa. This provides an intuitive mechanism for displaying the selected mode of line representation as well as an intuitive mechanism for changing the mode of line representation.

The present invention is not limited to the exemplary embodiments described herein; reference should be had to the appended claims.

1. A configuration tool, comprising:
a tangible, non-transitory computer-readable medium having computer-executable instructions for configuring a model of a technical system and displaying the model on a display connected to a computer;
wherein:
the model includes at least two model components;
each model component has at least one port;
each model component is displayable in an expanded component representation on the display;
each of the at least one port of each of the model components is connectable to at least one other port of another of the model components by a respective port association line;
each of the model components is displayable in an expanded line representation on the display along with each of the at least one port and the respective port association line; and
the respective port association lines connected to the ports of a selected model component are selectable so as to be displayed in a reduced line representation at least at ends thereof connected to the selected model component and independently of the representation of the selected model component, whereby in the reduced line representation, the selected model component has a reduced port different from the ports of the model component, and the ends of the port association lines connected to the ports of the selected model component in the expanded line representation are represented as one or more component association lines connected to the reduced port in the reduced line representation.

2. The configuration tool of claim 1, wherein the one or more component association lines are displayed differently from the port association lines.

3. The configuration tool of claim 2, wherein the one or more component association lines are at least one of a different color and a different line style with respect to the port association lines.

4. The configuration tool of claim 1, wherein in the reduced line representation, ports of model components that are connected with at least one port association line in the expanded line representation are displayed differently from ports of model components which are not connected with any port association line in the expanded line representation.

5. The configuration tool of claim 1, wherein the at least two model components are at least in part displayable in a reduced component representation,
whereby:
when the reduced component representation is selected for a model component, while at the same time the expanded line representation is selected for connected ports of the model component, unconnected ports of the model component are not displayed; and
when the reduced component representation is selected for the model component, while at the same time the reduced line representation is selected for connected ports of the model component, no ports of the model component are displayed.

6. The configuration tool of claim 1, wherein a part of the at least two model components are displayed with reduced line representation.

7. The configuration tool of claim 6, wherein the part of the at least two model components is displayed with reduced line representation based on a selection by a user.

8. The configuration tool of claim 6, wherein when the reduced line representation is selected for a particular model component, all port association lines of the particular model component connected to other connected model components are replaced by one or more component association lines.
